(19) United States
(12) Patent Application Publication
(10) Pub. No.: US 2023/0286469 A1
(43) Pub. Date: Sep. 14, 2023

(54) CONNECTION DEVICE FOR CONNECTING A WIPER BLADE OF AN OPTICAL SURFACE OF A VEHICLE TO A DRIVE ARM OF THE VEHICLE

(71) Applicant: Valeo Systèmes d'Essuyage, Le Mesnil Saint Denis (FR)

(72) Inventors: Vincent Gaucher, Le Mesnil Saint Denis (FR); Stéphane Houssat, Le Mesnil Saint Denis (FR)

(73) Assignee: Valeo Systèmes d'Essuyage, Le Mesnil Saint Denis (FR)

(21) Appl. No.: 18/016,786

(22) PCT Filed: Jul. 6, 2021
(86) PCT No.: PCT/EP2021/068599

§ 371 Date: Jan. 18, 2023

(30) Foreign Application Priority Data
Jul. 22, 2020 (FR) FR2007674

(51) Int. Cl. B60S 1/38; B60S 1/52

(52) U.S. Cl. CPC B60S 1/3862; B60S 1/3856; B60S 1/524

(57) ABSTRACT

The connection device (2) for connecting a wiper blade (3) of an optical surface (S) of a vehicle (V) to a drive arm (5) of the vehicle (V) comprises a circuit for channeling a liquid and comprising an inlet cannula (17) connected to a first duct (19a) and to a second duct (19b) both extending in a longitudinal direction of extension (AL) of the connection device (2). The first duct (19a) is capable of being in communication with the second duct (19b).

The present invention relates to the field of wiping and/or cleaning the optical surfaces of a motor vehicle. In particular, the present invention relates to a connection device which constitutes a wiper blade.

Wiper systems for motor vehicles generally comprise at least one drive arm that performs an angular back-and-forth movement over an optical surface. Such a drive arm drives at least one wiper blade comprising a wiper blade made of a resilient material, for example rubber, and pressed against the optical surface to be wiped.

The wiper blade is attached to the drive arm of the wiper system by a connection assembly configured such that, driven by the movements of the blade and the arm, the wiper blade rubs against the surface to be wiped and sweeps away the water and a certain amount of dirt, removing same from the driver’s field of vision.

In order to improve the wiping performance of the wiper blade, the connection assembly may be equipped with devices for supplying a cleaning and/or de-icing fluid conveyed from a tank located on the vehicle and sprayed in the direction of the optical surface to be wiped by nozzles located either around the optical surface to be wiped, or directly on the blades. This latter arrangement, where the fluid is ejected directly from the wiper blade and sprayed onto the optical surface to be wiped, ensures better distribution of the fluid and increases the precision and efficiency of cleaning and/or de-icing.

To this end, a connection device is generally assembled to the wiper blade which is provided with at least one ramp for delivering and spraying the cleaning and/or de-icing fluid. The connection device comprises at least one inlet fitting connected to a fluid intake, at least one outlet fitting connected to the ramp and an internal path for conveying the fluid from the inlet fitting to the outlet fitting.

In the prior art, such a connection device is generally designed to spray the cleaning fluid on only one lateral side of the wiper blade.

In order to adapt to left-hand-drive and right-hand-drive motor vehicles, it is generally necessary to provide two different structures of the wiper blade or a wiper blade structure having respectively, on each of its lateral sides, an inlet fitting, a delivery and spray ramp, and an outlet fitting.

However, these conventional wiper blades are generally complex, bulky and uneconomical.

There is thus a need to propose a technical solution to this problem by proposing a simple, compact, intuitive and versatile connection device.

According to one aspect, there is proposed a connection device for connecting a wiper blade for wiping an optical surface of a vehicle to a drive arm of the vehicle, said device comprising a circuit for channeling a liquid and comprising an inlet cannula connected to a first duct and to a second duct both extending in a longitudinal direction of extension of the connection device, the first duct being adapted to be in communication with the second duct.

Such a connection device advantageously makes it possible to use a single inlet fitting, in this case said inlet cannula, to supply the first duct and/or the second duct so as to make the structure of the connection device compact and universal. Note that such a connection device allows the user to spray cleaning and/or de-icing fluid from one of the two ducts or from both ducts so as to adapt the device to different use scenarios.

Advantageously, the connection device may for example be made in one piece.

According to one embodiment, the connection device is formed by a base comprising two lateral parts and surmounted by a flange in which the inlet cannula extends at least partially, the first duct and the second duct being respectively made in the two lateral parts of said base and adapted to be hydraulically connected to the inlet cannula via a first supply duct and a second supply duct, respectively.

Such a connection device advantageously allows a compact and versatile structure with a single inlet cannula so as to make the first duct and the second duct simultaneously usable for supplying the sprays of cleaning and/or de-icing fluid on the two lateral sides of the base.

The first supply duct may for example extend along a first axis transverse to the longitudinal direction and the second supply duct may for example extend along a second axis transverse to the longitudinal direction.

By way of non-limiting example, the inlet cannula may extend along a central longitudinal axis of the connection device, and the first duct and the second duct may be symmetrical with respect to said central longitudinal axis.

According to another embodiment, the first supply duct and the second supply duct respectively end in a first opening and a second opening which open out from the base to the outside of the device.

By way of indication but without limitation, the first opening and the second opening may for example be respectively closed off either by a first closure device adapted to close off only the first or second opening, or by a second closure device adapted to close off the first opening and the first duct, or the second opening and the second duct.

Advantageously, such a connection device offers the possibility of choosing the duct(s) to be used according to different use scenarios.

According to one embodiment, the first closure device comprises a first plug completely sealing the first or the second opening and closing off at most a part of the opening of the first or of the second duct in the first or second supply duct, respectively, and the second closure device comprises a second plug completely sealing the first or the second opening as well as the opening of the first or second duct in the first or second supply duct.

The first plug may for example be made of a first material and the second plug may for example be made of a second material, the first material and the second material being identical or preferably different, the first and/or the second plug being welded to the first and/or to the second opening, respectively.

According to another aspect, there is proposed a wiper system for wiping an optical surface of a vehicle comprising a wiper blade mechanically connected to a drive arm at least by a connection device as described above.

According to one embodiment, the wiper system further comprises an adapter means pivotally mounted on the connection device and adapted to connect said device to said drive arm.

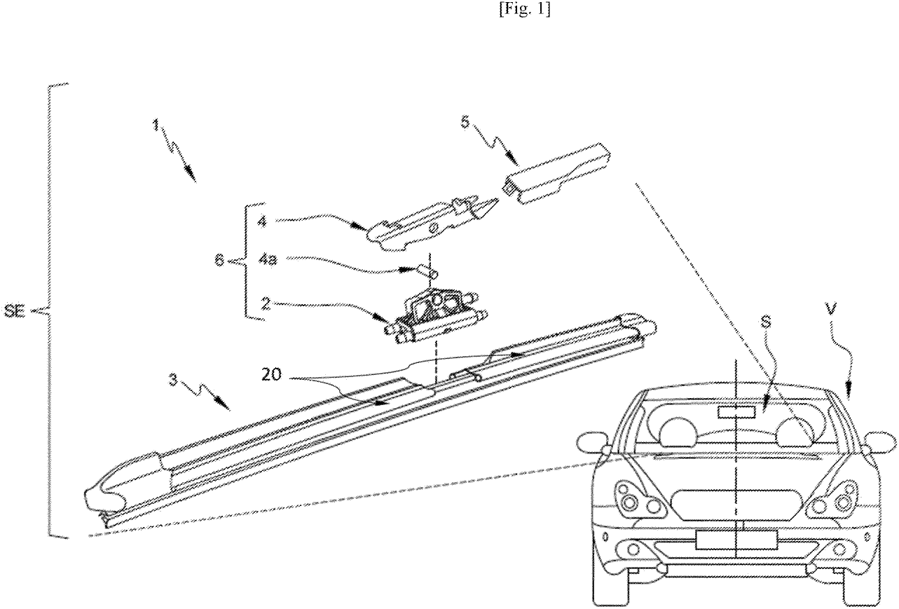

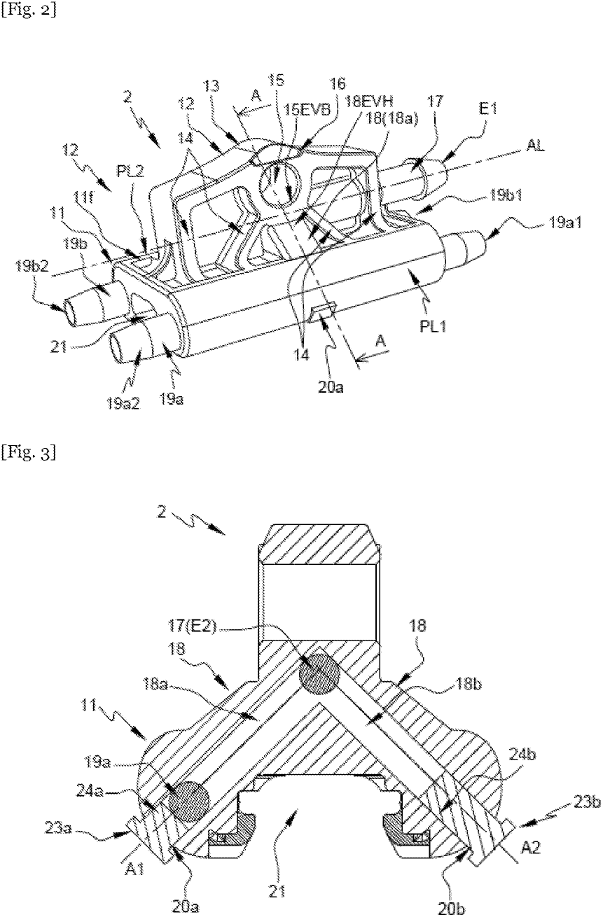

Further advantages and features of the invention will emerge on studying the detailed description of embodiments, which are in no way limiting, and the appended drawings in which:

[FIG. 1] shows a perspective view of an embodiment of a wiper system for wiping an optical surface of a vehicle.

[FIG. 2] shows a perspective view of an embodiment of a connection device.

[FIG. 3] shows a sectional view of the connection device along a plane A-A in FIG. 2.

Note that, in all FIGS. 1 to 3, identical elements bear the same reference numbers.

The reference V in FIG. 1 designates a vehicle V, in this case for example a motor vehicle comprising an optical surface S, in this case for example a windshield S of the motor vehicle. The motor vehicle V further comprises a wiper system SE for wiping the optical surface S of the motor vehicle V.

The wiper system SE has a wiper blade 1 configured to wipe the optical surface S. The wiper blade 1 comprises a connection device 2 carrying a wiper blade 3, and an adapter means 4 adapted to connect the connection device 2 to a drive arm 5.

Note that, in the assembled state, the wiper blade 3, the connection device 2, the adapter means 4 and the drive arm 5 of a motorized wiper mechanism form part of the wiper system SE.

For each drive arm concerned, such as hook arms, lateral pivot axis arms, longitudinal clipping/snap-fitting arms, etc., there will be a specific connection device 2 and a special adapter means 4.

In the example shown in FIG. 1, the connection device 2 is made in one piece. The adapter means 4, in this case for example a connector 4, is pivotally mounted on the connection device 2, in this case for example by means of a pivot pin 4a, and is adapted to be connected to the drive arm 5, in this case for example by clicking together longitudinally.

Alternatively, the connection device 2 may be made in several parts, for example a base configured to carry a wiper blade assembly 3 and an adapter configured to connect the base to the adapter means 4.

In order to form a wiper blade 1 making it possible to spray wiper liquids directly onto one or more optical surfaces to be wiped, a connection device may comprise one or more inlet cannulas intended to receive wiper liquids and one or more ducts coupled to the inlet cannula or cannulas and configured to distribute such wiper liquids.

An embodiment of the connection device 2 will now be described with reference to FIG. 2.

The connection device 2 has an elongate shape and includes a base 11 comprising an upper face 11f, and a central part 12 on top of the base 11 and extending longitudinally at the center of the upper face 11f of the base 11.

To be specific, the central part 12 forms an attachment 13 for a drive arm and/or an adapter means 4 able to connect the connection device 2 to a drive arm 5. To this end, the attachment 13 includes a flange comprising a plurality of ribs 14 which provide mechanical reinforcement for the flange, a through cavity 15 in the flange for receiving, according to a variant embodiment, a pivot pin, in particular of a drive arm of lateral pivot type, and ramps 16 of the through cavity 15 so as to facilitate mounting of the adapter means 4 on the connection device 2.

The central part 12 further comprises, near one of its longitudinal sides, an inlet cannula 17 longitudinally passing through at least a part, in this case for example half, of the flange of the central part 12. The inlet cannula 17 extends along a central longitudinal axis AL of the connection device 2.

The inlet cannula 17 has a first end El located close to said longitudinal side of the central part 12 and a second end E2 (see FIG. 3) inside the flange of the central part 12, in this case for example located below the through cavity 15.

The central part 12 also comprises on each of its lateral sides a central ramp 18 resting on the flange of the central part 12 and connected to the second end E2 of the inlet cannula 17. Each central ramp 18 ends in a top vertical end 18EVH located at a lower level of a bottom vertical end 15EVB of the through cavity 15.

As will be seen in more detail in FIG. 3, the central ramps 18 respectively comprise inside a first supply duct 18a and a second supply duct 18b (not visible in FIG. 2) hydraulically connected to said inlet cannula 17.

The base 11 has two lateral parts PL1, PL2 respectively comprising a first duct 19a and a second duct 19b. Each of these first and second ducts 19a, 19b longitudinally passes through the base 11 and is adapted to be hydraulically in communication with the corresponding supply duct 18a, 18b which is located on the same lateral side of the base 11.

The first supply duct 18a and the second supply duct 18b respectively end in a first opening 20a and a second opening 20b (visible in FIG. 3), which open out from the base 11 to the outside of the connection device 2.

Depending on the use scenario, the first opening 20a and the second opening 20b may be closed off by different closure devices so as to selectively connect the first duct 19a and/or the second duct 19b to said inlet cannula 17.

In other words, the inlet cannula 17 may be hydraulically connected to one of the first and second ducts 19a, 19b or to the first and second ducts 19a, 19b. In the latter case, the first duct 19a is hydraulically in communication with the second duct 19b.

As a result, the connection device 2 makes it possible to have a circuit for selectively channeling a liquid, in this case for example a wiper liquid, between the inlet cannula 17 and the first duct 19a only, between the inlet cannula 17 and the second duct 19b only, or between the inlet cannula 17 and the first and second ducts 19a, 19b.

Note that the connection device 2 comprises only a single inlet cannula 17, which makes the connection device 2 more compact and more economical to manufacture.

Each duct 19a, 19b comprises, near each of the longitudinal sides of the base 11, a duct end 19a1, 19a2, 19b1, 19b2 intended to be connected to a spray device.

According to an embodiment shown in FIG. 1, the spray device comprises spoilers 20 including spray holes for spraying wiper liquids onto the optical surface to be wiped.

The base 11 further comprises a holder channel 21 longitudinally passing through the base 11 and located between the two ducts 19a, 19b. The holder channel 21 is intended to carry, in a known manner, a wiper blade 22 and one or two corresponding vertebrae.

Note that the connection device 2 described above is advantageously made of the same synthetic material, for example plastic. This connection device 2 may thus be manufactured in a single molding operation, in particular by injection molding.

Reference is now made to FIG. 3 which shows a view of FIG. 2 in section along a vertical plane A-A.

As can be seen in FIG. 3, the section of the inlet cannula (17) has a round shape and the second end E2 of the inlet cannula 17 is hydraulically in communication with the first supply duct 18a and the second duct supply 18b.

By way of indication but without limitation, the section of the first supply duct 18a or of the second supply duct 18b has a round shape.

The first supply duct 18a extends along a first axis A1 transverse to the longitudinal direction and the second supply duct 18b extends along a second axis A2 transverse to the longitudinal direction.

By way of non-limiting example, the first axis A1 and the second axis A2 are perpendicular. The first supply duct 18a and the second supply duct 18b are symmetrical with respect to the inlet cannula 17 and with respect to said central longitudinal axis AL (visible in FIG. 2).

As stated above, the first supply duct 18a ends in a first opening 20a and the second supply duct 18b ends in a second opening 20b. The two openings 20a, 20b open out from the base 11 to the outside of the connection device 2.

The first opening 20a is closed off by a first closure device 23a. The first closure device 23a comprises a first plug 24a.

The first plug 24a completely seals the first opening 20a and closes off at most a part of the opening of the first duct 19a in such a way as to place the first duct 19a and the inlet cannula 17 in communication hydraulically.

According to one embodiment, the first plug 24a does not close off the opening of the first duct 19a.

The second opening 20b is closed off by a second closure device 23b. This second closure device 23b has an elongate shape and has a length greater than that of the first closure device 23a.

The second closure device 23b comprises a second plug 24b completely sealing the second opening 20b. Furthermore, the second plug 24b completely closes off the opening of the second duct 19b in the second supply duct 18b.

Therefore, the second duct 19b is not hydraulically in communication with the inlet cannula 17.

Note that the first plug 24a is made of a first material and the second plug 24b is made of a second material. The first material and the second material are identical or preferably different, for example plastic and/or rubber.

Depending on the use scenario, each plug 24a, 24b may be welded to the corresponding opening 20a, 20b. The first plug 24a and the second plug 24b may for example be welded by ultrasound to the first opening 20a and to the second opening 20b, respectively.

Thus, by choosing suitable closure devices for the first and second openings 20a, 20b, the single inlet cannula 17 of the connection device is adapted to be hydraulically in communication with the first duct 19a and/or the second duct 19b, which advantageously makes it possible to make the connection device 2 more compact and more versatile.

1. A connection device for connecting a wiper bladefor wiping an optical surface of a vehicleto a drive armof the vehicle, said device comprising:
a circuit for channeling a liquid and comprising an inlet cannulaconnected to a first duct and to a second duct both extending in a longitudinal direction of extension of the connection device,the first duct being adapted to be in communication with the second duct.

2. The device as claimed in claim 1, formed by a basecomprising two lateral parts and surmounted by a flange in which the inlet cannula extends at least partially, the first duct and the second duct being respectively made in the two lateral parts of said base and adapted to be hydraulically connected to the inlet cannula via a first supply duct and a second supply duct respectively.

3. The device as claimed in claim 2, wherein the first supply duct extends along a first axis transverse to the longitudinal direction and the second supply duct extends along a second axistransverse to the longitudinal direction.

4. The device as claimed in claim 1, wherein the inlet cannulaextends along a central longitudinal axisof the connection device, and wherein the first duct and the second duct are symmetrical with respect to said central longitudinal axis.

5. The device as claimed in claim 2, wherein the first supply duct and the second supply duct respectively end in a first opening and a second opening which open out from the base to the outside of the device .

6. The device as claimed in claim 5, wherein the first opening and the second opening are respectively closed off either by a first closure device adapted to close off only the first or second opening or by a second closure device adapted to close off the first opening and the first duct or the second opening and the second duct.

7. The device as claimed in claim 6, wherein the first closure device comprises a first plug completely sealing the first or the second opening and closing off at most a part of the opening of the first or of the second duct in the first or second supply duct, respectively, and the second closure device comprises a second plug completely sealing the first or the second opening as well as the opening of the first or second duct the first or second supply duct.

8. The device as claimed in claim 7, wherein the first plug is made of a first material and the second plug is made of a second material, the first material and the second material being different, the first and/or the second plug being welded to the first and/or to the second opening,respectively.

9. A wiper system for wiping an optical surface of a vehicle comprising: a wiper blade mechanically connected to a drive arm at least by a connection device as claimed in claim 1 .

10. The wiper system as claimed in claim 9, further comprising: an adapter meanspivotally mounted on the connection deviceand adapted to connect said deviceto said drive arm.
